(19) United States
(12) Patent Application Publication
(10) Pub. No.: US 2023/0192124 A1
(43) Pub. Date: Jun. 22, 2023

(54) Methods and Systems for Providing Remote Assistance to an Autonomous Vehicle

(71) Applicant: Waymo LLC, Mountain View, CA (US)

(72) Inventors: Collin Winter, San Francisco, CA (US); Vishay Nihalani, San Francisco, CA (US)

(73) Assignee: Waymo LLC, Mountain View, CA (US)

(21) Appl. No.: 18/064,612

(22) Filed: Dec. 12, 2022

Related U.S. Application Data
(60) Provisional application No. 63/292,231, filed on Dec. 21, 2021.

(51) Int. Cl. B60W 60/00; B60W 50/14; B60R 1/22

(52) U.S. Cl. CPC B60W 60/001; B60R 1/22; B60W 50/14; B60W 2050/146; B60W 2420/42

(57) ABSTRACT

Example embodiments relate to techniques for providing remote assistance to an autonomous vehicle. A computing device may receive location from a vehicle while the vehicle is autonomously navigating a path in an environment. Based on the location information, the computing device may display a representation of the environment of the vehicle that conveys lane information for the path and subsequently receive an input selecting a lane in the path. The input modified an availability of the lane in the path during subsequent navigation by the vehicle. The computing device may then provide navigation instructions to the vehicle based on availability of the lane in the path.

### CROSS REFERENCE TO RELATED APPLICATION

The present patent application claims priority to U.S. Provisional Pat. Application No. 63/292,231, filed Dec. 21, 2021, which is hereby incorporated by reference in its entirety.

### BACKGROUND

Advancements in computing, sensors, and other technologies have enabled vehicles to safely navigate between locations autonomously, i.e., without requiring input from a human driver. By processing sensor measurements of the surrounding environment in near real-time, an autonomous vehicle can safely transport passengers or objects (e.g., cargo) between locations while avoiding obstacles, obeying traffic requirements, and performing other actions that are typically conducted by the driver. Shifting both decision-making and control of the vehicle over to vehicle systems can allow the vehicle’s passengers to devote their attention to tasks other than driving. Some situations, however, can arise during navigation that may impact a vehicle’s ability to navigate toward a destination.

### SUMMARY

Example embodiments described herein relate to techniques for providing remote assistance to an autonomous vehicle. Such remote assist techniques can enable a human operator, a passenger, or a remote computing device to provide guidance or another form of instructions to a vehicle in various dynamic situations that arise during navigation. In some instances, remote assistance techniques disclosed herein allow for the modification of lanes available for the vehicle to use during subsequent navigation and/or the identification of a lead vehicle for the vehicle to follow for a threshold distance or a threshold duration of time. In some examples, remote assistance techniques further involve an operator providing instructions that selects a particular area for the vehicle to pull-over until an obstacle is resolved.

In one aspect, an example method is provided. The method involves receiving, at a computing device, location information from a vehicle. The vehicle is autonomously navigating a path in an environment, and the computing device is positioned remotely from the vehicle. The method further involves displaying a representation of the environment of the vehicle based on the location information, where the representation of the environment conveys lane information for the path. The method additionally involves receiving a first input selecting a first lane in the path, where the first input modifies an availability of the first lane in the path during subsequent navigation by the vehicle, and providing navigation instructions to the vehicle based on the availability of the first lane in the path.

In another aspect, an example system is provided. The system includes a vehicle and a computing device, which is configured to receive location information from a vehicle. The vehicle is autonomously navigating a path in an environment, and the computing device is positioned remotely from the vehicle. The computing device is further configured to display a representation of the environment of the vehicle based on the location information, where the representation of the environment conveys lane information for the path. The computing device is also configured to receive a first input selecting a first lane in the path, where the first input modifies an availability of the first lane in the path during subsequent navigation by the vehicle, and provide navigation instructions to the vehicle based on the availability of the first lane in the path.

In yet another example, an example non-transitory computer readable medium having stored therein program instructions executable by a computing system comprising one or more processors to cause the computing system to perform operations is provided. The operations include receiving location information from a vehicle, where the vehicle is autonomously navigating a path in an environment, and the computing device is positioned remotely from the vehicle. The operations further include displaying a representation of the environment of the vehicle based on the location information, where the representation of the environment conveys lane information for the path. The operations also include receiving a first input selecting a first lane in the path, where the first input modifies an availability of the first lane in the path during subsequent navigation by the vehicle, and providing navigation instructions to the vehicle based on the availability of the first lane in the path.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a vehicle, according to example implementations.

FIG. 2A illustrates a side view of a vehicle, according to one or more example embodiments.

FIG. 2B illustrates a top view of a vehicle, according to one or more example embodiments.

FIG. 2C illustrates a front view of a vehicle, according to one or more example embodiments.

FIG. 2D illustrates a back view of a vehicle, according to one or more example embodiments.

FIG. 2E illustrates an additional view of a vehicle, according to one or more example embodiments.

FIG. 3 is a simplified block diagram for a computing system, according to one or more example embodiments.

FIG. 4 is a system for wireless communication between computing devices and a vehicle, according to one or more example embodiments.

FIG. 5 illustrates a computing device displaying a graphical user interface for enabling remote assistance, according to one or more example embodiments.

FIG. 6 illustrates a remote assistance situation, according to one or more example embodiments.

FIG. 7 illustrates another remote assistance situation, according to one or more example embodiments.

FIG. 8 illustrates an additional remote assistance situation, according to one or more example embodiments.

FIG. 9 is a flow chart of a method for providing remote assistance, according to one or more example embodiments.

FIG. 10 is a schematic diagram of a computer program, according to one or more example embodiments.

FIG. 11 is a graphical user interface for obtaining operator input, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

As a vehicle navigates to a destination in an autonomous or semi-autonomous mode, the vehicle may encounter some situations that can interfere and potentially block or otherwise disrupt its current trajectory. For instance, construction sites, poorly marked roadways, stranded vehicles, accidents, fallen objects, and/or obstructed views of signs or pathways are some potential situations encountered during navigation that can alter and sometimes temporarily limit a vehicle’s ability to navigate to its destination. In situations where vehicle systems fail to independently overcome obstacles encountered during navigation or fail to determine an alternative option with enough confidence to proceed, the vehicle systems may seek assistance. As such, remote assistance offers a solution wherein a remote computing system and/or remote operator can provide some form of instructions that helps guide the vehicle through the situation. For instance, a vehicle may transmit data and/or a request for assistance to a remote computing device used by a remote human operator. The computing device may provide a graphical user interface (GUI) and/or other tools that allow the operator to provide route instructions or another form of assistance that the vehicle can use to overcome an obstacle. In some cases, a remote operator may use information (e.g., sensor data) received from one or multiple vehicles to monitor the one or multiple vehicles and provide assistance in-real time when a vehicle encounters a potential obstacle that could be resolved quicker with assistance.

Example embodiments presented herein involve remote assistance techniques that can accelerate the assistance provided to vehicles in various situations. Such remote assist techniques can be used to guide or otherwise assist an autonomous or semi-autonomous vehicle through various difficult navigations situations that can arise, such as construction zones, occluded vision areas, and other dynamic environments encountered during navigation. Some example remote assist techniques may involve providing tools that allow for modifying lane availability for the vehicle to subsequently use. For instance, an operator may select a lane displayed via a map of the area of the vehicle, which may trigger the remote computing system to highlight the entire lane and provide instructions that modifies availability of the lane for subsequent use by the vehicle. In some examples, a remote computing device may provide tools that allows an operator to identify a lead vehicle for the vehicle to follow, and/or selecting an area for the vehicle to pull-over until the surrounding environment permits further navigation. The different techniques present options for a remote operator to review and implement without requiring too much time and effort to complete.

By way of an example, a computing device may initially receive location information and/or other contextual information from a vehicle that is autonomously or semi-autonomously navigating a path toward a destination. In particular, the information obtained from the vehicle can be used by the computing device to provide context regarding the vehicle’s situation. In some cases, the location information can be general location information obtained from a global positioning system (GPS) located on the vehicle and/or may include other data, such as velocity and heading information from a vehicle inertial measurement unit (IMU). In some instances, the location information may localize the vehicle relative to aspects of a map, such as identifying the vehicle at a particular intersection. The computing device may also receive video, images, and/or other sensor data from the vehicle.

In some embodiments, the computing device is positioned remotely from the vehicle and can used by one or multiple human operators that may provide assistance to the vehicle. Through a wireless connection between the computing device and the vehicle, the human operator can monitor navigation of the vehicle to provide assistance when needed or can receive a request for assistance from the vehicle that initiates the communication session between the computing device and the vehicle. In other implementations, the computing device can be a personal computing device of a passenger, such as a smartphone or a wearable device.

The computing device can use the location information and/or other information provided by the vehicle to display a representation of the vehicle’s environment, such as a road map depicting roads in the vehicle’s area. For instance, the computing device can obtain map data from local memory and/or from another computing system (e.g., a remote server). The computing device can also augment road maps to convey trajectory information for the vehicle. As an example, the vehicle may transmit its current path and/or target destination, which can allow the computing device to display the road map with arrows or other visual cues that may assist the human operator understand the vehicle’s situation. In addition, in some implementations, the computing device may display images (e.g., live video) and/or other sensor data obtained from vehicle sensors to convey the vehicle’s environment. For instance, video/images and/or other sensor data can show lane information for the vehicle’s current path. In addition, the computing device can display a combination of sensor data and map information in some examples.

In some cases, remote assistance may involve modifying the lanes available for the vehicle to use during subsequent navigation. For instance, a human operator can use the computing device to instruct the vehicle to use a particular lane, avoid a particular lane or multiple lanes, and/or identify lanes that are available/unavailable and enable vehicle systems to navigate based on the lane availability information provided. To receive human operator instructions, the computing device may use a GUI to display information about the vehicle’s situation, such as the representation of the vehicle’s environment. For example, the human operator can directly select a lane represented in the display in order to adjust the vehicle’s ability to use that lane during subsequent navigation. In some cases, the human operator can identify multiple lanes as available or unavailable for the vehicle to use during navigation after receiving the lane modification information.

Lane assistance can differ within example embodiments. In some implementations, the computing device can be configured to display instructions via text (or in another format). For instance, the text can request for the human operator to select lanes to make the lanes temporarily unavailable for subsequent navigation by the vehicle. The text can form and ask natural language questions that prompt the operator to perform actions. In other implementations, the instructions may indicate that selecting any lane identifies that lane as available. In addition, the computing device can also allow the human operator to select a lane for the vehicle to use during subsequent navigation, which can cause the vehicle to transition to use that lane when permitted by the environment. In some instances, the computing device can also use audio alerts to request a human operator to modify lanes.

In addition, a human operator can modify lane availability for a threshold distance from a current location of the vehicle or for a threshold duration of time. This way, the human operator can assist a vehicle overcome an obstacle positioned nearby while also allowing the vehicle to resume use of a lane after a period of time or after traveling a given distance past the obstacle. In some examples, the user interface can allow an operator to select from options, such as specifying on a road map that “this lane is blocked,” “switch to this lane,” “move one lane left/right” and/or “the following lanes are open, pick from them.” By using natural language options, the computing device can enable a human operator to understand lane modification options that are available and select from among the options to assist the vehicle. In some examples, the options can also include other techniques to assist the vehicle, such as “follow an identified lead vehicle” or “pull over” in a particular area.

In some examples, the GUI may display a representation of the road and convey a position of the vehicle on the road from a bird’s eye view. The GUI may allow an operator to select a lane, which then triggers the computing device to graphically highlight the entire lane up to a threshold distance from the vehicle (or graphically highlight a portion of the lane). In some examples, the graphical highlight can involve the GUI changing a color of the road (e.g., from a road neutral color to green or red) based on the desired availability selected by the operator. In some cases, the operator may tap or otherwise select a lane of the road with one or multiple selections via the GUI to change the lane from available to unavailable for subsequent use by the vehicle.

Disclosed lane modification remote assist techniques can offer a faster way for an operator to cause a vehicle to change lanes and without requiring the vehicle to stop prior to performing the lane change, which results in the vehicle moving in a more natural way similar to how a driver would change lanes. In some instances, a sign (e.g., orange diamond sign) can trigger the request for assistance that allows the operator to explicitly mark one or more lanes for the vehicle to use in forward navigation. Further, lanes can also be selected and combined by a remote operator so that the vehicle opts to use one or the other when available. This may be particularly helpful in trucking or freeway driving where a vehicle is operating at a high speed and needs assistance or input regarding an upcoming closed or blocked lane. In addition, lane modification techniques may be applied to multiple vehicles. For instance, a human operator can modify lane availability for multiple vehicles that may encounter a particular portion of road during navigation. This can be used to avoid construction sites, accidents, or other obstacles that may prevent use of a particular lane for a prolonged period of time. As an example result, vehicles can automatically plan on using a different route or lane based on the lane modification information previously provided by the human operator.

The computing device can also enable the human operator to provide other instructions that can be used to modify subsequent navigation by a vehicle. The user interface techniques can also allow an operator to assist a vehicle by providing instructions to follow a particular agent in the environment, such as another vehicle operating in the same area. For instance, the interface can allow the operator to instruct the vehicle to follow the path of another vehicle. As an example, when a vehicle encounters freeway construction, the lanes can be shifted left or right by a few meters. In such a situation, following a lead vehicle may help keep the vehicle in the temporary lanes established for the construction. In some embodiments, the computing system may use natural language instructions requesting an operator to select one or multiple vehicles for an autonomous vehicle to use to model near term navigation, such as during a particular stretch of roadway and/or for a threshold duration of time.

In some cases, the computing device can also enable a human operator to select operations for a vehicle to perform based on another vehicle detected within sensor data received from the vehicle. For instance, the computing device may display images received from the vehicle. Some of these images may depict other vehicles positioned nearby the vehicle in near real-time. As such, the computing device can provide the option for a vehicle to select another vehicle positioned nearby and cause the vehicle to follow the selected vehicle for a threshold duration or a threshold distance. This strategy can help a vehicle circumvent obstacles by following another vehicle that can help guide the vehicle around the obstacles. In other examples, the human operator can also select other vehicles or obstacles in the environment for the vehicle receiving assistance to avoid. Such selections may increase the buffer around the other vehicles or obstacles implemented by the vehicle control system.

In some cases, the user interface can enable a remote operator to cause a vehicle to pause or stop in a specified location or nearby that location. Upon receiving the instructions, the vehicle may use onboard sensor data and systems to determine whether the vehicle could fit in the selected location based on the size and orientation of the vehicle. Such techniques can prevent the vehicle from partially entering a spot while also blocking parts of a sidewalk, road, or other objects in the environment (e.g., a stop sign, a bus stop, or a fire hydrant). The vehicle may receive instructions and find a nearby pull over location without stopping first, which results in a lower latency form of assistance that is less disruptive to the flow of traffic. In some applications, the remote interface may limit options for the remote operator to select from only options that can accommodate the size and heading of the vehicle. The options may also be limited based on potential exit plans for the vehicle to leave the spot.

In addition, the vehicle may be configured to perform a similar analysis prior to requesting assistance. For instance, the vehicle may select a nearby location to pull over that accommodates both the entire length and current orientation of the vehicle. The selection may also depend on the exit strategy for the vehicle (e.g., could the vehicle pull forward after leaving the spot or would reversing be required?). In some examples, a remote operator can use the remote computing device to provide a series of instructions to one or multiple vehicles. For instance, the remote operator can specify lanes to use on different portions of a route and also designate a location for the vehicle to pull over.

Disclosed example techniques can allow for a remote operator to provide assistance to a vehicle with less latency, which can allow the vehicle to receive and execute operations based on the assistance before the vehicle even comes to a stop in some instances. In addition, these techniques can be useful for autonomous trucking and/or in specific situations, such as marking waypoints that adhere to different lane layouts that can arise within construction zones or other dynamic environments. In some embodiments, remote assistance may involve establishing a secure communication connection between a human operator and one or more vehicle systems or passengers traveling within a vehicle. The human operator may receive sensor data depicting the environment in near real-time and provide assistance to the vehicle (or passengers) immediately.

Example systems within the scope of the present disclosure will now be described in greater detail. An example system may be implemented in or may take the form of an automobile, but other example systems can be implemented in or take the form of other vehicles, such as cars, trucks, motorcycles, buses, boats, airplanes, helicopters, lawn mowers, earth movers, boats, snowmobiles, aircraft, recreational vehicles, amusement park vehicles, farm equipment, construction equipment, trams, golf carts, trains, trolleys, and robot devices. Other vehicles are possible as well.

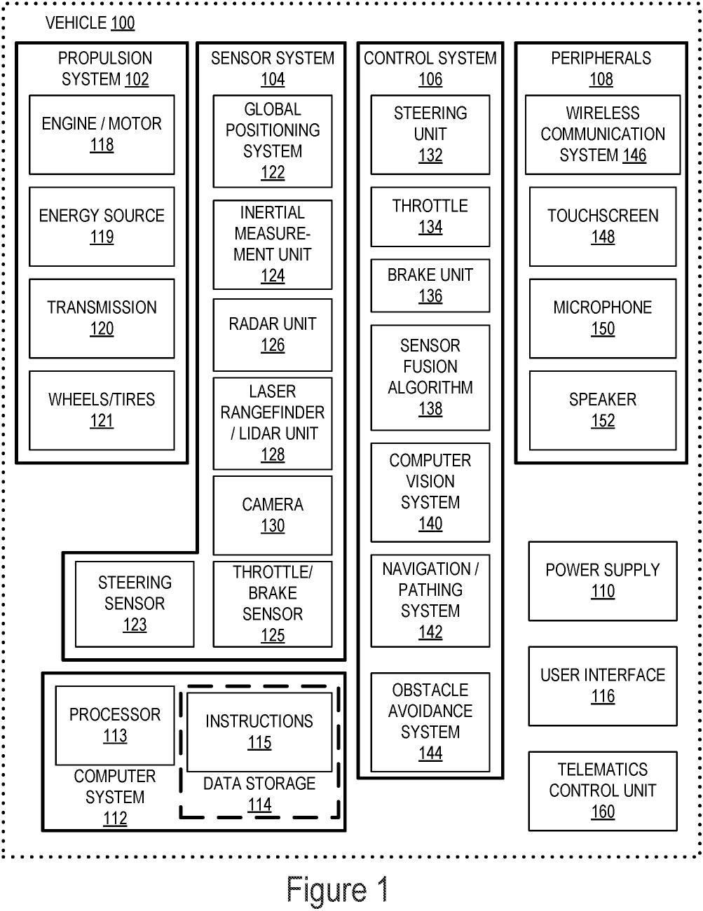

Referring now to the figures, FIG. 1 is a functional block diagram illustrating vehicle 100, which represents a vehicle capable of operating fully or partially in an autonomous mode. More specifically, vehicle 100 may operate in an autonomous mode without human interaction (or reduced human interaction) through receiving control instructions from a computing system (e.g., a vehicle control system). As part of operating in the autonomous mode, vehicle 100 may use sensors (e.g., sensor system 104) to detect and possibly identify objects of the surrounding environment to enable safe navigation. In some implementations, vehicle 100 may also include subsystems that enable a driver (or a remote operator) to control operations of vehicle 100.

As shown in FIG. 1, vehicle 100 includes various subsystems, such as propulsion system 102, sensor system 104, control system 106, one or more peripherals 108, power supply 110, computer system 112, data storage 114, and user interface 116. The subsystems and components of vehicle 100 may be interconnected in various ways (e.g., wired or secure wireless connections). In other examples, vehicle 100 may include more or fewer subsystems. In addition, the functions of vehicle 100 described herein can be divided into additional functional or physical components, or combined into fewer functional or physical components within implementations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, one or more electric motors, steam engine, or Stirling engine, among other possible options. For instance, in some implementations, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some implementations, energy source 119 may include a combination of fuel tanks, batteries, capacitors, and/or flywheel.

Transmission 120 may transmit mechanical power from the engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example implementations. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, one or more radar units 126, laser rangefinder / LIDAR unit 128, camera 130, steering sensor 123, and throttle/brake sensor 125, among other possible sensors. In some implementations, sensor system 104 may also include sensors configured to monitor internal systems of the vehicle 100 (e.g., O₂ monitors, fuel gauge, engine oil temperature, condition of brakes).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar unit 126 may represent one or more systems configured to use radio signals to sense objects (e.g., radar signals), including the speed and heading of the objects, within the local environment of vehicle 100. As such, radar unit 126 may include one or more radar units equipped with one or more antennas configured to transmit and receive radar signals as discussed above. In some implementations, radar unit 126 may correspond to a mountable radar system configured to obtain measurements of the surrounding environment of vehicle 100. For example, radar unit 126 can include one or more radar units configured to couple to the underbody of a vehicle.

Laser rangefinder / LIDAR 128 may include one or more laser sources, a laser scanner, and one or more detectors, among other system components, and may operate in a coherent mode (e.g., using heterodyne detection) or in an incoherent detection mode. Camera 130 may include one or more devices (e.g., still camera or video camera) configured to capture images of the environment of vehicle 100.

Steering sensor 123 may sense a steering angle of vehicle 100, which may involve measuring an angle of the steering wheel or measuring an electrical signal representative of the angle of the steering wheel. In some implementations, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, the angle of the gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in enabling navigation by vehicle 100, such as steering unit 132, throttle 134, brake unit 136, sensor fusion algorithm 138, computer vision system 140, navigation / pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some implementations, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some implementations, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software operable to process and analyze images in an effort to determine objects, environmental objects (e.g., stop lights, road way boundaries, etc.), and obstacles. As such, computer vision system 140 may use object recognition, Structure from Motion (SFM), video tracking, and other algorithms used in computer vision, for instance, to recognize objects, map an environment, track objects, estimate the speed of objects, etc.

Navigation / pathing system 142 may determine a driving path for vehicle 100, which may involve dynamically adjusting navigation during operation. As such, navigation / pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may securely and wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 may communicate with a wireless local area network (WLAN) using WiFi or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some implementations. For instance, power supply 110 may include one or more batteries configured to provide electrical power. Vehicle 100 may also use other types of power supplies. In an example implementation, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory computer readable medium, such as data storage 114. In some implementations, computer system 112 may represent a plurality of computing devices that may serve to control individual components or subsystems of vehicle 100 in a distributed fashion.

In some implementations, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, and control system 106), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of an environment of vehicle 100 operating in an autonomous mode. The state of the environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar unit 126 may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors. In addition, vehicle 100 may also include telematics control unit (TCU) 160. TCU 160 may enable vehicle connectivity and internal passenger device connectivity through one or more wireless technologies.

Although FIG. 1 shows various components of vehicle 100, i.e., wireless communication system 146, computer system 112, data storage 114, and user interface 116, as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

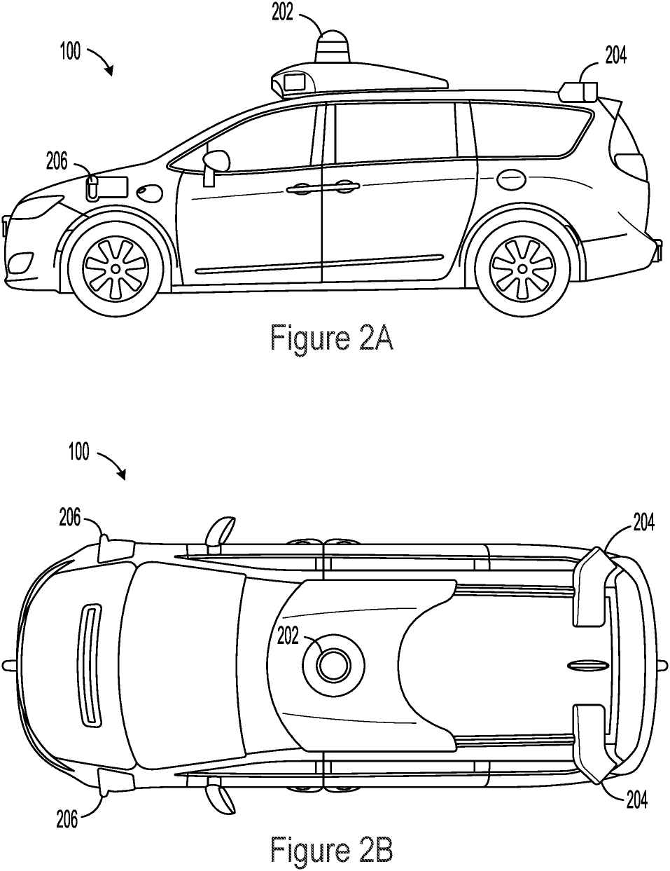

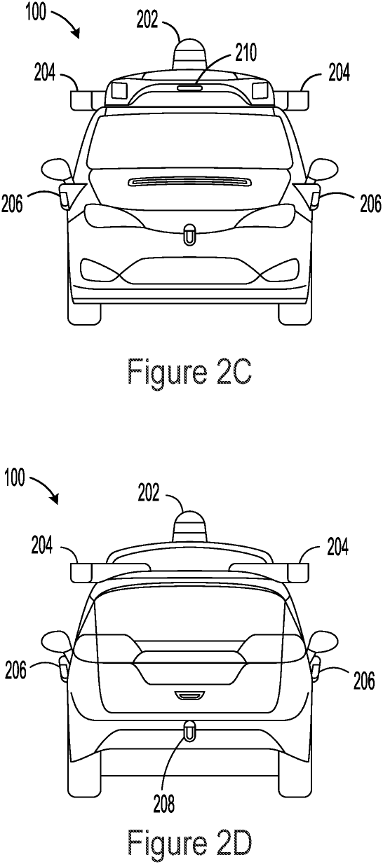

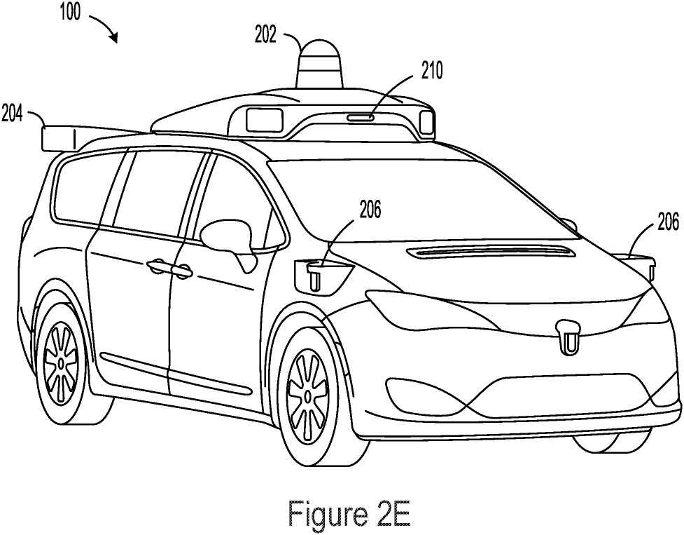

FIGS. 2A, 2B, 2C, 2D, and 2E illustrate different views of a physical configuration of vehicle 100. The various views are included to depict example sensor positions 202, 204, 206, 208, 210 on vehicle 100. In other examples, sensors can have different positions on vehicle 100. Although vehicle 100 is depicted in FIGS. 2A-2E as a van, vehicle 100 can have other configurations within examples, such as a truck, a car, a semi-trailer truck, a motorcycle, a bus, a shuttle, a golf cart, an off-road vehicle, robotic device, or a farm vehicle, among other possible examples.

As discussed above, vehicle 100 may include sensors coupled at various exterior locations, such as sensor positions 202-210. Vehicle sensors include one or more types of sensors with each sensor configured to capture information from the surrounding environment or perform other operations (e.g., communication links, obtain overall positioning information). For example, sensor positions 202-210 may serve as locations for any combination of one or more cameras, radars, LIDARs, range finders, radio devices (e.g., Bluetooth and/or 802.11), and acoustic sensors, among other possible types of sensors.

When coupled at the example sensor positions 202-210 shown in FIGS. 2A-2E, various mechanical fasteners may be used, including permanent or non-permanent fasteners. For example, bolts, screws, clips, latches, rivets, anchors, and other types of fasteners may be used. In some examples, sensors may be coupled to the vehicle using adhesives. In further examples, sensors may be designed and built as part of the vehicle components (e.g., parts of the vehicle mirrors).

In some implementations, one or more sensors may be positioned at sensor positions 202-210 using movable mounts operable to adjust the orientation of one or more sensors. A movable mount may include a rotating platform that can rotate sensors so as to obtain information from multiple directions around vehicle 100. For instance, a sensor located at sensor position 202 may use a movable mount that enables rotation and scanning within a particular range of angles and/or azimuths. As such, vehicle 100 may include mechanical structures that enable one or more sensors to be mounted on top the roof of vehicle 100. Additionally, other mounting locations are possible within examples. In some situations, sensors coupled at these locations can provide data that can be used by a remote operator to provide assistance to vehicle 100.

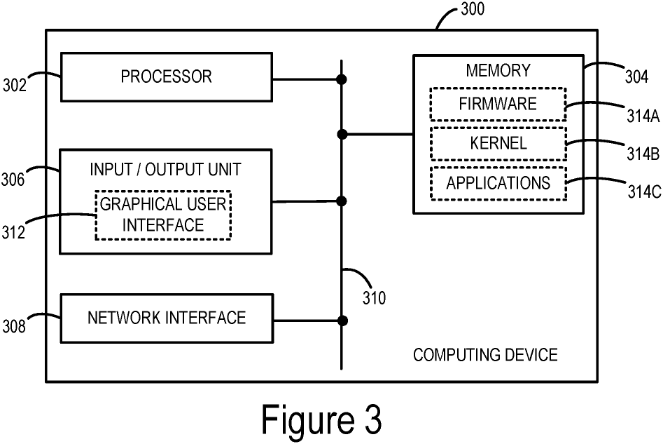

FIG. 3 is a simplified block diagram exemplifying computing device 300, illustrating some of the components that could be included in a computing device arranged to operate in accordance with the embodiments herein. Computing device 300 could be a client device (e.g., a device actively operated by a user (e.g., a remote operator)), a server device (e.g., a device that provides computational services to client devices), or some other type of computational platform. In some embodiments, computing device 300 may be implemented as computer system 112, which can be located on vehicle 100 and perform processing operations related to vehicle operations. For example, computing device 300 can be used to process sensor data received from sensor system 104. Alternatively, computing device 300 can be located remotely from vehicle 100 and communicate via secure wireless communication. For example, computing device 300 may operate as a remotely positioned device that a remote human operator can use to communicate with one or more vehicles.

In the example embodiment shown in FIG. 3, computing device 300 includes processing system 302, memory 304, input / output unit 306 and network interface 308, all of which may be coupled by a system bus 310 or a similar mechanism. In some embodiments, computing device 300 may include other components and/or peripheral devices (e.g., detachable storage, sensors, and so on).

Processing system 302 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processing system 302 may be one or more single-core processors. In other cases, processing system 302 may be one or more multi-core processors with multiple independent processing units. Processing system 302 may also include register memory for temporarily storing instructions being executed and related data, as well as cache memory for temporarily storing recently-used instructions and data.

Memory 304 may be any form of computer-usable memory, including but not limited to random access memory (RAM), read-only memory (ROM), and non-volatile memory. This may include flash memory, hard disk drives, solid state drives, rewritable compact discs (CDs), rewritable digital video discs (DVDs), and/or tape storage, as just a few examples.

Computing device 300 may include fixed memory as well as one or more removable memory units, the latter including but not limited to various types of secure digital (SD) cards. Thus, memory 304 can represent both main memory units, as well as long-term storage. Other types of memory may include biological memory.

Memory 304 may store program instructions and/or data on which program instructions may operate. By way of example, memory 304 may store these program instructions on a non-transitory, computer-readable medium, such that the instructions are executable by processing system 302 to carry out any of the methods, processes, or operations disclosed in this specification or the accompanying drawings.

As shown in FIG. 3, memory 304 may include firmware 314A, kernel 314B, and/or applications 314C. Firmware 314A may be program code used to boot or otherwise initiate some or all of computing device 300. Kernel 314B may be an operating system, including modules for memory management, scheduling and management of processes, input / output, and communication. Kernel 314B may also include device drivers that allow the operating system to communicate with the hardware modules (e.g., memory units, networking interfaces, ports, and busses), of computing device 300. Applications 314C may be one or more user-space software programs, such as web browsers or email clients, as well as any software libraries used by these programs. In some examples, applications 314C may include one or more neural network applications and other deep learning-based applications. Memory 304 may also store data used by these and other programs and applications.

Input / output unit 306 may facilitate user and peripheral device interaction with computing device 300 and/or other computing systems. Input / output unit 306 may include one or more types of input devices, such as a keyboard, a mouse, one or more touch screens, sensors, biometric sensors, and so on. Similarly, input / output unit 306 may include one or more types of output devices, such as a screen, monitor, printer, speakers, and/or one or more light emitting diodes (LEDs). Additionally or alternatively, computing device 300 may communicate with other devices using a universal serial bus (USB) or high-definition multimedia interface (HDMI) port interface, for example. In some examples, input / output unit 306 can be configured to receive data from other devices. For instance, input / output unit 306 may receive sensor data from vehicle sensors.

As shown in FIG. 3, input / output unit 306 includes GUI 312, which can be configured to provide information to a remote operator or another user. GUI 312 may involve one or more display interfaces, or another type of mechanism for conveying information and receiving inputs. In some examples, the representation of GUI 312 may differ depending on a vehicle situation. For example, computing device 300 may provide GUI 312 in a particular format, such as a format with a single selectable option for a remote operator to select from.

Network interface 308 may take the form of one or more wireline interfaces, such as Ethernet (e.g., Fast Ethernet, Gigabit Ethernet, and so on). Network interface 308 may also support communication over one or more non-Ethernet media, such as coaxial cables or power lines, or over wide-area media, such as Synchronous Optical Networking (SONET) or digital subscriber line (DSL) technologies. Network interface 308 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 308. Furthermore, network interface 308 may comprise multiple physical interfaces. For instance, some embodiments of computing device 300 may include Ethernet, BLUETOOTH®, and Wifi interfaces. In some embodiments, network interface 308 may enable computing device 300 to connect with one or more vehicles to allow for remote assistance techniques presented herein.

In some embodiments, one or more instances of computing device 300 may be deployed to support a clustered architecture. The exact physical location, connectivity, and configuration of these computing devices may be unknown and/or unimportant to client devices. Accordingly, the computing devices may be referred to as “cloud-based” devices that may be housed at various remote data center locations. In addition, computing device 300 may enable the performance of embodiments described herein, including efficient assignment and processing of sensor data.

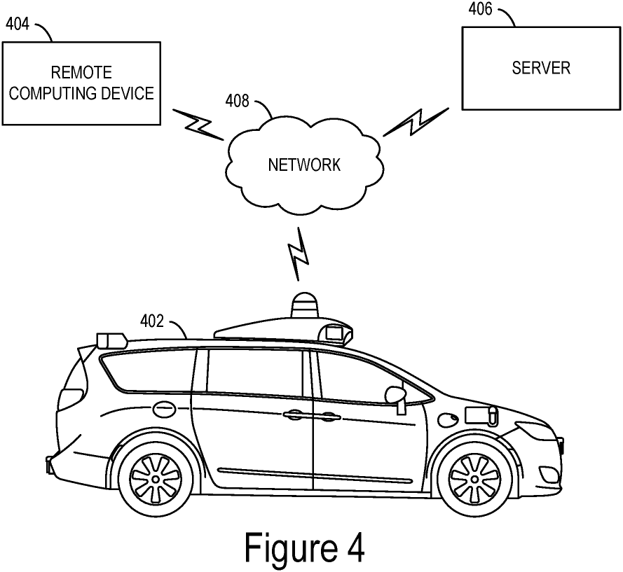

FIG. 4 is a system for wireless communication between computing devices and a vehicle, according to one or more example embodiments. System 400 may enable vehicles (e.g., vehicle 402) to obtain remote assistance from human operators using computing devices positioned remotely from the vehicles (e.g., remote computing device 404). Particularly, system 400 is shown with vehicle 402, remote computing device 404, and server 406 communicating wirelessly via network 408. System 400 may include other components not shown within other embodiments, such as firewalls and multiple networks, among others.

Vehicle 402 may transport passengers or objects between locations, and may take the form of any one or more of the vehicles discussed above, including passenger vehicles, cargo shipping vehicles, farming and manufacturing vehicles, and dual-purpose vehicles. When operating in an autonomous mode (or semi-autonomous mode), vehicle 402 may navigate to pick up and drop off passengers (or cargo) between desired destinations. In some embodiments, vehicle 402 can operate as part of a fleet of vehicles, such as within a fleet of ride-share vehicles.

Remote computing device 404 may represent any type of device related to enabling remote assistance techniques, including but not limited to those described herein. Within examples, remote computing device 404 may represent any type of device configured to (i) receive information related to vehicle 402, (ii) provide an interface (e.g., a GUI, physical input interfaces) through which a human operator can in turn perceive the information and input a response related to the information, and (iii) transmit the response to vehicle 402 or to other devices (e.g., storage at server 406). As such, remote computing device 404 may take various forms, such as a workstation, a desktop computer, a laptop, a tablet, a mobile phone (e.g., a smart phone), a wearable device (e.g., a headset) and/or a server. In some examples, remote computing device 404 may include multiple computing devices operating together in a network configuration. In further embodiments, remote computing device 404 may resemble a vehicle simulation center with the remote operator positioned as the drive of the simulation center. In addition, remote computing device 404 may operate as a head mountable device that can simulate the perspective of vehicle 402.

The position of remote computing device 404 relative to vehicle 402 can vary within examples. For instance, remote computing device 404 may have a remote position from vehicle 402, such as operating inside a physical building. In another example, remote computing device 404 may be physically separate from vehicle 402, but operate inside vehicle 402 to enable a passenger of vehicle 402 to act as the human operator. For instance, remote computing device 404 can be a touchscreen device accessible to a passenger of vehicle 402. Operations described herein that are performed by remote computing device 404 may be additionally or alternatively performed by vehicle 402 (i.e., by any system(s) or subsystem(s) of vehicle 100). In other words, vehicle 402 may be configured to provide a remote assistance mechanism with which a driver or passenger of the vehicle can interact.

Operations described herein can be performed by any of the components communicating via network 408. For instance, remote computing device 404 may determine remote assist options for a human operator to review based on different levels of information provided by vehicle 402. In some embodiments, vehicle 402 may determine potential navigation options for remote computing device 404 to display for a remote operator to review. Potential options could include routes, vehicle movements, and other navigation parameters for review by remote computing device 404 and/or a remote operator using remote computing device 404.

In other embodiments, remote computing device 404 may analyze sensor data or other information from vehicle 402 to determine the situation and potential options for a remote operator to review. For instance, remote computing device 404 may determine a route and/or operations for vehicle 402 to execute using information from vehicle 402 and/or other external sources (e.g., server 406). In some embodiments, remote computing device 404 may generate a GUI to display one or more selectable options for review by a remote operator.

Server 406 may be configured to wirelessly communicate with remote computing device 404 and vehicle 402 via network 408 (or perhaps directly with remote computing device 404 and/or vehicle 402). As such, server 406 may represent any computing device configured to receive, store, determine, and/or send information relating to vehicle 402 and the remote assistance thereof. As such, server 406 may be configured to perform any operation(s), or portions of such operation(s), that is/are described herein as performed by remote computing system 404 and/or vehicle 402. Some implementations of wireless communication related to remote assistance may utilize server 406, while others may not.

Network 408 represents infrastructure that can enable wireless communication between computing devices, such as vehicle 402, remote computing device 404, and server 406. For example, network 408 can correspond to a wireless communication network, such as the Internet or a cellular wireless communication network.

In some embodiments, remote assistance for vehicles can originate from a network of remote operators. For example, a vehicle may submit a request for assistance that is received at an entry point of the network. The entry point may connect the request with a remote operator that can provide assistance. The remote operator may be selected based on credentials associated with the remote operator that indicate that she or he is able to handle the type of assistance that is being requested and/or the operator’s availability, among other potential parameters. The entry point may analyze information within the request to route requests for assistance accordingly. For example, the network of remote operators may be used to provide assistance to an entire fleet of autonomous vehicles.

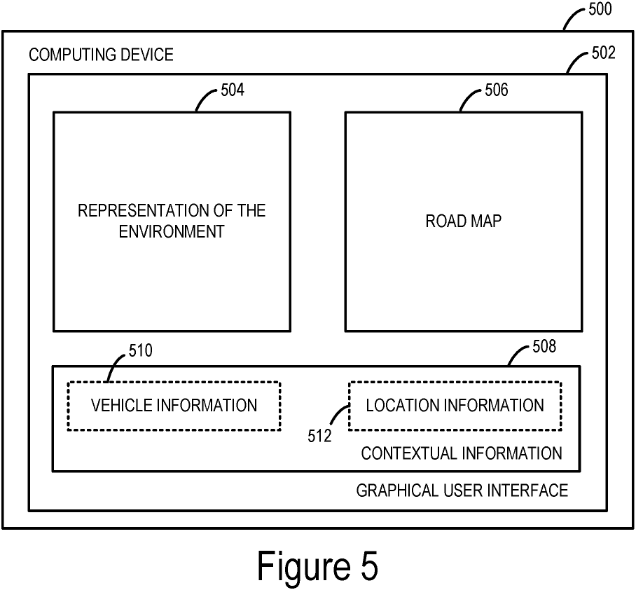

FIG. 5 illustrates computing device 500 displaying GUI 502 for enabling delivery of remote assistance to a vehicle. In some examples, computing device 500 can be implemented as computing device 300 shown in FIG. 3 and may enable wireless communication between human operators and vehicles.

In some cases, computing device 500 may receive sensor data from a vehicle that encountered a situation causing issues and subsequently alert a human operator to provide assistance via various alert techniques, such as visual, audio, and/or tactile alerts. In other cases, a vehicle and computing device 500 may establish a wireless communication connection prior to the vehicle requiring some form of assistance to resolve a situation. For instance, an operator may be tasked with monitoring vehicles through a particular situation or stretch of roadway (e.g., a construction site) and computing device 500 may automatically establish a connection with a vehicle in advance after detecting that the vehicle is approaching the situation or roadway. In some examples, computing device 500 may be used to enable a human operator to monitor a fleet of vehicles. For instance, a central system may route requests for assistance to available operators. In another example, the routing system can be a decentralized system that is supported via various nodes, such as computing device 500.

In addition, computing device 500 may perform remote assist techniques in some examples, which can involve providing assistance to overcome various situations. For instance, computing device 500 may represent a powerful computing system that can perform simulations to check potential outcomes based on navigation information provided by a vehicle. As an example, a vehicle may provide video data and one or multiple proposed trajectories for the vehicle to perform, which can be analyzed and/or simulated by computing device 500 to generate an output. The output may indicate which trajectory the vehicle should perform in some instances. The computing device 500 may also notify a human operator when the output indicates that none of the proposed trajectories satisfy a success threshold. In some examples, computing device 500 can also generate proposed trajectories for a vehicle to perform based on sensor data representing the environment. For instance, computing device 500 can use sensor data from the vehicle to simulate different maneuvers until a particular trajectory satisfies a success threshold. In some cases, computing device 500 may submit a request for a human operator to review and approve the generated trajectory prior to sending the trajectory to the vehicle for subsequent performance.

In the example embodiment, GUI 502 includes visual elements, such as environment representation 504, road map 506, and contextual information 508. The visual elements are shown for illustration purposes and can be combined, further divided, and/or replaced or supplemented by other elements in other examples. For instance, GUI 502 may display only road map 506 in some implementations. In addition, the arrangement of the elements is for illustration purposes and can vary within implementations.

GUI 502 represents a system of interactive visual components for computer software, which can be used to display objects that convey information to a human operator and also represent actions that can be taken by the operator.. For instance, computing device 500 may generate GUI 502 based on templates stored in memory and customized to a vehicle’s given situation, which can enable an available remote operator to review and provide assistance. In some cases, GUI 502 can allow the remote operator to provide remote assistance that can be used to generate augmented route instructions that navigate vehicles with respect to an encountered obstacle or series of obstacles (e.g., a construction site). Computing device 500 may display GUI 502 on a display interface, such as a touch screen, external monitor, and/or a display interface associated with a head-mounted wearable computing device (e.g., augmented reality).

Computing device 500 may use GUI 502 to enable interaction between a human operator and vehicles. For instance, the human operator may provide inputs to computing device 500 via touch inputs, buttons or hardware inputs, motion and/or vocal inputs. In some embodiments, computing device 500 may include a microphone that can receive vocal inputs and use speech recognition software to derive operations based on the vocal inputs from the operator. In addition, in some implementations, computing device 500 may resemble a vehicle emulator that can simulate the vehicle’s perspective. The various elements (e.g., environment representation 504, road map 506, and contextual information 508) shown in GUI 502 can be customized according to different settings enabled by computing device 500.

Environment representation 504 is an object displayable via GUI 502 that can represent the current environment (or a recent environment) from one or more perspectives, such as the perspective of the vehicle or from another view (e.g., a simulated bird’s-eye view).. For instance, environment representation 504 may involve displaying images and/or video of the environment as captured by vehicle cameras. In other instances, sensor data from different types of sensors can be used to generate and provide environment representation 504 displayed via GUI 502. For instance, environment representation 504 may include data based on a point cloud developed using radar and/or LIDAR. As such, environment representation 504 can be updated in near-real time as the wireless communication between computing device 500 and a vehicle enables more information to be received and displayed.

In some cases, environment representation 504 can represent (e.g., show) the positions of obstacles or other environment elements that may have disrupted the path of travel of the vehicle as well as other features positioned nearbyvehicle’s surrounding environment. For example, environment representation 504 may depict other vehicles, pedestrians, bicycles, traffic signals and signs, road elements and barriers, buildings, and/or other features within the vehicle’s environment. Computing device 500 may use visual indicators, such as (e.g., arrows, boxes, and colors, etc. or a combination of visual indicators) to highlight aspects of the environment representation 504, such as the obstacles blocking the path of travel of the vehicle. For example, computing device 500 may use computer vision to detect elements within images and identify elements using different colors, such as red boxes to identify pedestrians, blue boxes for other vehicles, and green boxes for stationary objects. Computing device 500 may highlight lanes in different colors in some instances to convey information to a remote operator or passenger. and identify objects in the environment.

Computing device 500 may further obtain andalso display road map 506 and/or other types of map data via GUI 502 based on a location of the vehicle. Road map 506 may represent one or more maps of roads that depend on the current location and route of the vehicle. For instance, the vehicle may provide GPS measurements or another indication of the vehicle’s location within the request for assistance or during subsequent communication between the vehicle and computing device 500. By using the vehicle’s location, computing device 500 can acquire road map 506 and further enhance the information included within environment representation 504 and/or other objects displayed via GUI 502. For instance, road map 506 can be augmented to display obstacles detected in vehicle sensor data from the assistance requesting vehicle and/or other vehicles that captured measurements of that area. In some examples, computing device 500 can determine and display environment representation 504 as an elevated view of the vehicle and nearby surroundings estimated based on road map 506 and the sensor data from the vehicle. In some examples, GUI 502 may include both a sensor perspective of the vehicle’s environment and the elevated view estimated based on one or both of the sensor data and/or road map 506.

GUI 502 also includes contextual information 508, which may convey additional information to supplement a remote operator’s understanding of the vehicle’s situation. As shown in FIG. 5, contextual information 508 includes vehicle information 510 and location information 512. Vehicle information 510 may indicate a variety of information about the vehicle, such as the type of vehicle, the vehicle sensors on the vehicle, the quantity of the passengers, and target destination, etc. Location information 522 may represent information based on the current location of the vehicle, such as map data depicting the environment and lanes available for the vehicle to use. Contextual information 508 may also specify information related to the situation, such as how long has the vehicle been stranded and a reason proposed by the vehicle for the stranding.

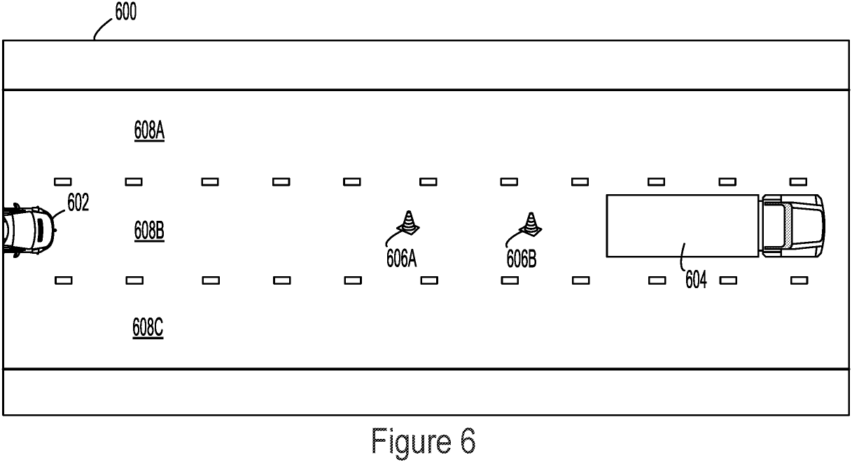

FIG. 6 illustrates remote assistance situation 600, which shows vehicle 602 encountering stranded truck 604 during navigation on the road that includes lane 606A, lane 606B, and lane 606C. As shown, vehicle 602 may detect one or both traffic cones 606A, 606B that are positioned to signal that truck 604 is temporarily stranded and determine that the combination of traffic cones 606A-606B and truck 604 block its current path in lane 606B. Situation 600 represents a common scenario encountered during navigation where truck 604 may have a flat tire, broken axle, or another issue that caused truck 604 to break down in the middle of the road in lane 608B.

In some implementations, a remote operator may already be monitoring navigation by vehicle 602 prior to vehicle 602 encountering traffic cones 606A, 606B that indicate truck 604 is stranded. The remote operator may provide assistance to vehicle 602 to circumvent truck 604. For instance, the remote operator may modify lane availability for the road by identifying lanes 608A, 608C as available and lane 608B as unavailable. In other implementations, vehicle 602 may encounter stranded truck 604 and submit a request for remote assistance. The request can be routed to a system that assigns the task to the computing device of a remote operator available to assist vehicle 602. As such, the human operator may use a GUI provided by the remote computing device to modify the availability of one or more lanes 608A-608C for subsequent navigation by vehicle 602. Remote assist techniques can involve using natural language options, specific lane selection (e.g., select lane 608A to use until pass truck 604), or general modification of lane availability for vehicle systems to use during subsequent route determination. Other lane modification techniques may be used to assist vehicle 602. Vehicle 602 can proceed with navigation around truck 604 via using lane 608A or lane 608C, which may depend on remote assistance when vehicle systems are unable to resolve the situation independently.

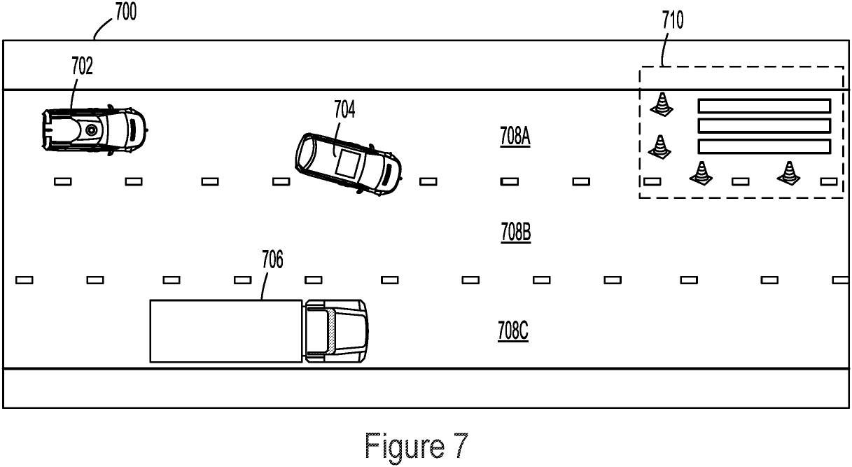

FIG. 7 illustrates remote assistance situation 700, which shows a scenario where a remote operator may provide instructions to vehicle 702 to follow vehicle 704 based on the detection of obstacles 710 occupying a part of lane 708A. The remote operator may use vehicle 704 as a leader to guide vehicle 702 around obstacles 710.

In the example embodiment, vehicle 702 may be traveling toward a destination when vehicle sensors detect obstacles 710. For instance, lidar, radar, and/or cameras can detect that obstacles 710 are located in the same lane 708A as vehicle 702. In some cases, vehicle systems may be able to determine a control strategy that safely circumvents obstacles 710 without the need for assistance. In particular, vehicle systems may cause vehicle 702 to change into lane 708B to navigate around obstacles 710. In other cases, vehicle systems may fail to identify a navigation strategy that safely avoids obstacles 710 above a confidence threshold, which may cause vehicle 702 to use remote assistance.

In some cases, vehicle 702 may propose a navigation option that can be approved, rejected, or modified via a remote computing device, passenger, or human operator. For instance, a human operator may review situation 700 and provide vehicle 702 with instructions to move into lane 708B or to follow vehicle 704 for a threshold duration, a threshold distance, or when the operator provides further instructions. The computing device used to provide remote assistance to vehicle 702 can display a representation of the environment. For instance, the computing device may display video or images received from the vehicle camera system of vehicle 702.

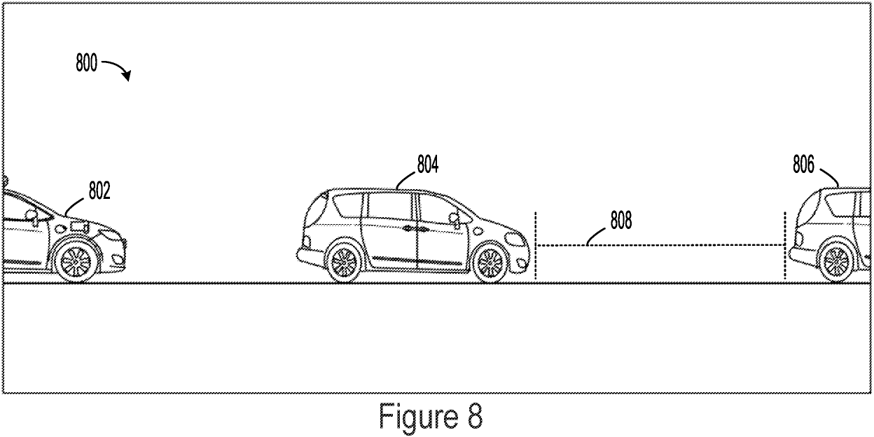

FIG. 8 illustrates remote assistance situation 800, which shows vehicle 802 performing advanced spatial analysis in response to receiving a pull-over request from a remote operator. In particular, vehicle 802 may use sensor data from one or multiple types of sensor to determine if vehicle 802 can safely pull-over and stop in area 808 positioned in between vehicle 804 and vehicle 806.

In some cases, vehicle 802 may determine that area 808 is able to accommodate the full length and size of vehicle 802. This may involve factoring the current orientation of vehicle 802 and other vehicle parameters, such as width, length, and height in some situations. In addition, vehicle 802 can also consider other factors, such as a speed limit of the road and corresponding traffic level. In addition, vehicle 802 may consider other factors, such as the availability of larger nearby areas that could accommodate a pull-over maneuver by vehicle 802.

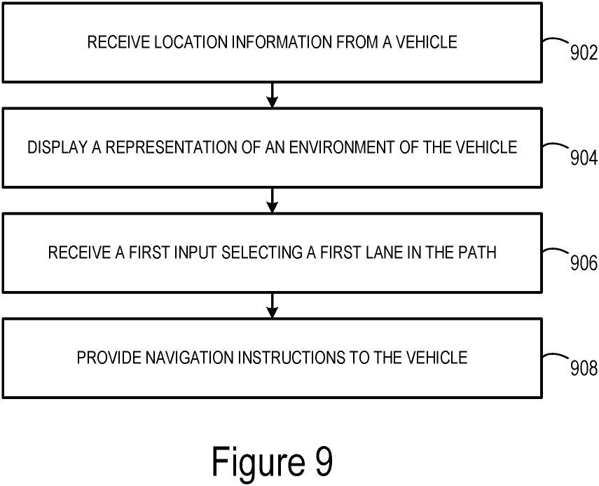

FIG. 9 is a flow chart of a method for vehicle occupancy confirmation, according to example implementations. Method 900 represents an example method that may include one or more operations, functions, or actions, as depicted by one or more of blocks 902, 904, 906, and 908, each of which may be carried out by any of the systems, devices, and/or vehicles shown in FIGS. 1-8, among other possible systems. For instance, system 400 depicted in FIG. 4 may enable execution of method 900.

Those skilled in the art will understand that the flowchart described herein illustrates functionality and operations of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 902, method 900 involves receiving location information from a vehicle, which is autonomously navigating a path in an environment. The computing device may be positioned remotely from the vehicle. In some instances, the computing device may receive a request for assistance from the vehicle, which may include the location information and images from a vehicle camera system.

At block 904, method 900 involves displaying a representation of the environment of the vehicle based on the location information. In particular, the representation of the environment conveys lane information for the path in some instances. For example, the representation can be based on images from the vehicle camera system and/or map data from one or more maps representing the area in which the vehicle is located. The images may depict obstacles in the vehicle’s environment.

At block 906, method 900 involves receiving a first input selecting a first lane in the path. The first input modifies an availability of the first lane in the path during subsequent navigation by the vehicle. In some examples, the computing device can display the representation of the environment with an indication of the modified availability for the first lane in the path in response to receiving the first input selecting the first lane in the path. In some instances, the computing device can display the first lane in a color that differentiates the first lane from other lanes in the path.

In some examples, the computing device may provide an indication with the representation of the environment that conveys a selection of a given lane in the path labels the given lane as unavailable during subsequent navigation by the vehicle. The computing device may then determine that the first lane in the path is unavailable for subsequent navigation by the vehicle for at least a threshold distance from a current location of the vehicle or for at least a threshold duration of time, which may be determined responsive to receiving the first input selecting the first lane in the path. In some instances, the computing device may provide text or audio that conveys the selection of the given lane in the path labels the given lane unavailable during subsequent navigation.

In some examples, the computing device may provide an indication with the representation of the environment that conveys a selection of a given lane in the path labels the given lane as available during subsequent navigation by the vehicle. As such, responsive to receiving the first input selecting the first lane in the path, the computing device may determine that the first lane in the path is available for subsequent navigation by the vehicle for at least a threshold distance from a current location of the vehicle or for at least a threshold duration of time.

In some examples, the computing device may identify obstacles in the environment using computer vision and/or another technique. For instance, the computing device can identify and subsequently visually highlight (e.g., place boxes around) obstacles detected in the vehicle’s environment. The computing device can also determine if some obstacles are located proximate to the first lane in the vehicle’s path and provide one or more suggestions for modifying availability of the first lane in the path (and potentially other lanes) based on determining that obstacles are located in the path. In other implementations, the computing device may automatically modify availability of the first lane in the path based on determining that the one or more obstacles are located in the first lane in the path. The computing device can display the representation of the environment with an indication of the modified availability of the first lane in the path.

At block 908, method 900 involves providing navigation instructions to the vehicle based on the availability of the first lane in the path.

In some examples, method 900 further involves receiving a second input selecting a second lane in the path where the second input modifies an availability of the second lane in the path during subsequent navigation by the vehicle. As such, the computing device may then provide navigation instructions based on the availability of both the first lane and the second lane.

In some examples, method 900 further involves receiving a second input selecting a particular area on the representation of the environment, and providing navigation instructions to the vehicle based on the availability of the first lane in the path and the second input selecting the particular area based on receiving the second input. As an example result, the vehicle can be configured to determine whether the particular area on the representation is suitable for performing a pull-over maneuver.

In some examples, the computing device may receive, from the vehicle, images depicting a forward path of the vehicle and cause the representation of the environment to convey the forward path of the vehicle based on the images. The computing device may further be configured to detect an obstacle in the forward path of the vehicle and augment the representation of the environment to indicate a location of the obstacle relative to the vehicle. In addition, the computing device can be further configured to display an indication that a second lane in the path is unavailable for selection based on the location of the obstacle relative to the vehicle.

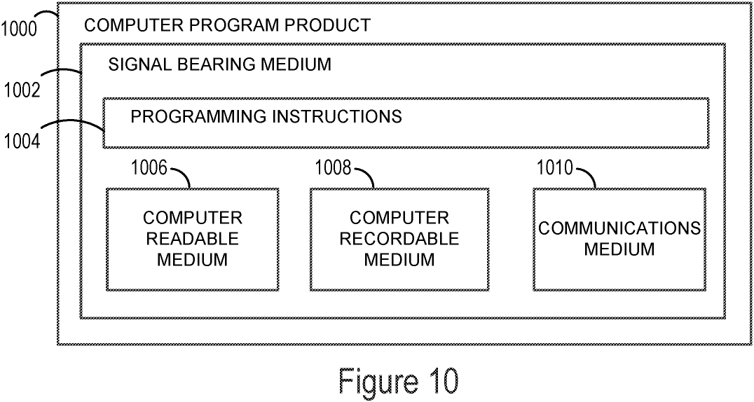

FIG. 10 is a schematic diagram of a computer program, according to an example implementation. In some implementations, the disclosed methods may be implemented as computer program instructions encoded on a non-transitory computer-readable storage media in a machine-readable format, or on other non-transitory media or articles of manufacture.

In the embodiment shown in FIG. 10, computer program product 1000 is provided using signal bearing medium 1002, which may include one or more programming instructions 1004 that, when executed by one or more processors may provide functionality or portions of the functionality described above with respect to FIGS. 1-9.

Signal bearing medium 1002 may encompass a non-transitory computer-readable medium 1006, such as, but not limited to, a hard disk drive, a Compact Disc (CD), a Digital Video Disk (DVD), a digital tape, memory, components to store remotely (e.g., on the cloud) etc. In some implementations, signal bearing medium 1002 may encompass computer recordable medium 1008, such as, but not limited to, memory, read/write (R/W) CDs, R/W DVDs, etc.

In some implementations, signal bearing medium 1002 may encompass communications medium 1010, such as, but not limited to, a digital and/or an analog communication medium (e.g., a fiber optic cable, a waveguide, a wired communications link, a wireless communication link, etc.). Similarly, signal bearing medium 1002 may correspond to a remote storage (e.g., a cloud). A computing system may share information with the cloud, including sending or receiving information. For example, the computing system may receive additional information from the cloud to augment information obtained from sensors or another entity. Thus, for example, signal bearing medium 1002 may be conveyed by a wireless form of communications medium 1010.

One or more programming instructions 1004 may be, for example, computer executable and/or logic implemented instructions. In some examples, a computing device such as computer system 112 shown in FIG. 1 or computing device 300 shown in FIG. 3 may be configured to provide various operations, functions, or actions in response to programming instructions 1004 conveyed to the computer system by one or more of computer readable medium 1006, computer recordable medium 1008, and/or communications medium 1010. The non-transitory computer readable medium could also be distributed among multiple data storage elements and/or cloud (e.g., remotely), which could be remotely located from each other. Computing device that executes some or all of the stored instructions could be a vehicle. Alternatively, the computing device that executes some or all of the stored instructions could be another computing device, such as a server.

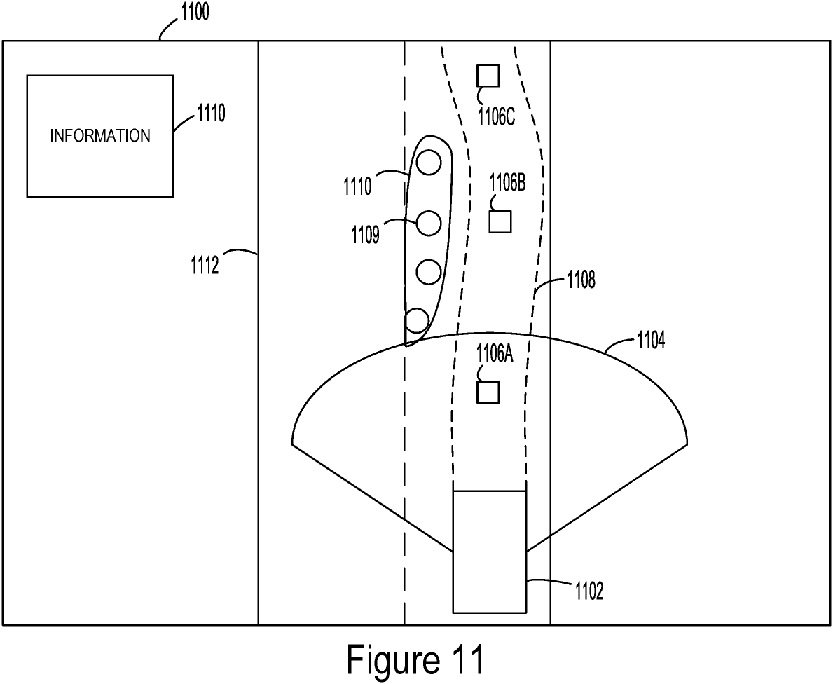

FIG. 11 depicts GUI 1100, which represents an example interface that an operator may use to remotely assist a vehicle. In the example embodiment, GUI 1100 may represent a real-world situation of a vehicle and is shown depicting vehicle 1102 traveling on road 1112. The computing device displaying GUI 1100 may use information received from the vehicle and/or other sources (e.g., a map database) to represent the vehicle’s situation from a bird-eye’s view as shown in FIG. 11. In particular, GUI 1100 will update in real-time as new information is received from the vehicle indicating changes in the orientation and location of the vehicle. In other examples, GUI 1100 may further depict the vehicle’s situation from a different perspective, such as if the remote operator was driving the vehicle.

As shown, GUI 1100 displays a forward-facing sensor field of view 1104 for vehicle 1102 and also shows placement of traffic barriers 1109 positioned in the lane due to construction. The computing system displaying GUI 1100 may perform disclosed operations to enhance tools available for an operator to use to provide assistance to the vehicle. For instance, the computing system may position outline 1110 around traffic barriers 1109 to highlight space that is off limits to the vehicle. In addition, in response to receiving one or multiple waypoint selections 1106A, 1106B, 1106C, the computing system may generate path 1108 that the vehicle can follow to avoid the off limit area caused by traffic barriers 1109. GUI 1100 further includes information 1110, which may provide useful data and/or ask questions for the remote operator to consider. As such, GUI 1100 can be used to perform disclosed techniques herein. For instance, an operator can use GUI 1100 to adjust lane availability that an autonomous vehicle can subsequently use.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

What is claimed is:

1. A method comprising:
receiving, at a computing device, location information from a vehicle, wherein the vehicle is autonomously navigating a path in an environment, and wherein the computing device is positioned remotely from the vehicle;
based on the location information, displaying a representation of the environment of the vehicle, wherein the representation of the environment conveys lane information for the path;
receiving a first input selecting a first lane in the path, wherein the first input modifies an availability of the first lane in the path during subsequent navigation by the vehicle; and
providing navigation instructions to the vehicle based on the availability of the first lane in the path.

2. The method of claim 1, further comprising:
receiving a second input selecting a second lane in the path, wherein the second input modifies an availability of the second lane in the path during subsequent navigation by the vehicle; and
wherein providing navigation instructions to the vehicle comprises:
providing navigation instructions based on the availability of both the first lane and the second lane.

3. The method of claim 1, further comprising:
providing an indication with the representation of the environment that conveys a selection of a given lane in the path labels the given lane as unavailable during subsequent navigation by the vehicle; and
responsive to receiving the first input selecting the first lane in the path, determining that the first lane in the path is unavailable for subsequent navigation by the vehicle for at least a threshold distance from a current location of the vehicle or for at least a threshold duration of time.

4. The method of claim 3, wherein providing the indication with the representation of the environment comprises:
providing text or audio that conveys the selection of the given lane in the path labels the given lane unavailable during subsequent navigation.

5. The method of claim 1, further comprising:
providing an indication with the representation of the environment that conveys a selection of a given lane in the path labels the given lane as available during subsequent navigation by the vehicle; and
responsive to receiving the first input selecting the first lane in the path, determining that the first lane in the path is available for subsequent navigation by the vehicle for at least a threshold distance from a current location of the vehicle or for at least a threshold duration of time.

6. The method of claim 1, wherein receiving location information from the vehicle comprises:
receiving a request for assistance from the vehicle, wherein the request for assistance includes the location information and images from a vehicle camera system.

7. The method of claim 6, wherein displaying the representation of the environment of the vehicle comprises:
displaying the images from the vehicle camera system, wherein the images depict one or more obstacles in the environment of the vehicle.

8. The method of claim 7, further comprising:
identifying the one or more obstacles in the environment;
determining the one or more obstacles are located proximate the first lane in the path; and
providing a suggestion for modifying availability of the first lane in the path based on determining that the one or more obstacles are located in the first lane in the path.

9. The method of claim 7, further comprising:
identifying the one or more obstacles in the environment;
determining the one or more obstacles are located proximate the first lane in the path;
automatically modifying availability of the first lane in the path based on determining that the one or more obstacles are located in the first lane in the path; and
displaying the representation of the environment with an indication of the modified availability of the first lane in the path.

10. The method of claim 1, further comprising:
responsive to receiving the first input selecting the first lane in the path, displaying the representation of the environment with an indication of the modified availability for the first lane in the path.

11. The method of claim 10, wherein displaying the representation of the environment with the indication of the modified availability for the first lane in the path comprises:
displaying the first lane in a color that differentiates the first lane from other lanes in the path.

12. The method of claim 1, further comprising:
receiving a second input selecting a particular area on the representation of the environment; and
based on receiving the second input, providing navigation instructions to the vehicle based on the availability of the first lane in the path and the second input selecting the particular area, wherein the vehicle is configured to determine whether the particular area on the representation is suitable for performing a pull-over maneuver.

13. The method of claim 1, further comprising:
based on displaying the representation of the environment, receiving a given input that selects a second vehicle in the environment of the vehicle; and
based on receiving the given input that selects the second vehicle, providing instructions to the vehicle to follow the second vehicle for a threshold duration or a threshold distance.

14. A system comprising:
a vehicle; and
a computing device configured to:
receive location information from a vehicle, wherein the vehicle is autonomously navigating a path in an environment, and wherein the computing device is positioned remotely from the vehicle;
based on the location information, display a representation of the environment of the vehicle, wherein the representation of the environment conveys lane information for the path;
receive a first input selecting a first lane in the path, wherein the first input modifies an availability of the first lane in the path during subsequent navigation by the vehicle; and
provide navigation instructions to the vehicle based on the availability of the first lane in the path.

15. The system of claim 14, wherein the representation of the environment depicts the first lane in a first color and a second lane in a second color.

16. The system of claim 14, wherein the computing device is further configured to:
receive, from the vehicle, images depicting a forward path of the vehicle; and
wherein the representation of the environment conveys the forward path of the vehicle based on the images.

17. The system of claim 16, wherein the computing device is further configured to:
detect an obstacle in the forward path of the vehicle; and
augment the representation of the environment to indicate a location of the obstacle relative to the vehicle.

18. The system of claim 17, wherein the computing device is further configured to display an indication that a second lane in the path is unavailable for selection based on the location of the obstacle relative to the vehicle.

19. The system of claim 14, wherein the computing device is positioned at a remote location relative to the vehicle.

20. A non-transitory computer-readable medium configured to store instructions, that when executed by a computing system comprising one or more processors, causes the computing system to perform operations comprising:
receiving location information from a vehicle, wherein the vehicle is autonomously navigating a path in an environment, and wherein the computing device is positioned remotely from the vehicle;
based on the location information, displaying a representation of the environment of the vehicle, wherein the representation of the environment conveys lane information for the path;
receiving a first input selecting a first lane in the path, wherein the first input modifies an availability of the first lane in the path during subsequent navigation by the vehicle; and
providing navigation instructions to the vehicle based on the availability of the first lane in the path.
